(19) United States
(12) Patent Application Publication
(10) Pub. No.: US 2014/0298411 A1
(43) Pub. Date: Oct. 2, 2014

(54) ACCESSING A SECURE ELEMENT THROUGH A MANAGEABLITY ENGINE

(71) Applicant: HEWLETT-PACKARD DEVELOPMENT COMPANY, L.P., (US)

(72) Inventors: Robin T. Castell, Houston, TX (US); Timothy Neill, Houston, TX (US); Donald Gonzalez, Cupertino, CA (US)

(73) Assignee: HEWLETT-PACKARD DEVELOPMENT COMPANY, L.P., Houston, TX (US)

(21) Appl. No.: 13/850,883

(22) Filed: Mar. 26, 2013

(51) Int. Cl. H04W 12/08

(52) U.S. Cl. CPC H04W 12/08
USPC 726/2

(57) ABSTRACT

One example provides a system including a Near Field Communication (NFC) module including a secure element and a host computer communicatively coupled to the NFC module. The host computer includes a manageability engine. A secure NFC application of the host computer is to access the secure element through the manageability engine.

### BACKGROUND

Near Field Communication (NFC) is used to establish wireless connections between suitably equipped devices that are in close proximity to each other. The wireless connections may be established between an active device (i.e., a device that has a power supply) and a passive device (i.e., a device that does not have a power supply) or between two active devices.

### BRIEF DESCRIPTION OF THE DRAWINGS

FIG. 1 is a block diagram illustrating one example of a Near Field Communication (NFC) system.

FIG. 2 is a hardware block diagram illustrating one example of an NFC system.

FIG. 3 is a diagram illustrating one example of an NFC stack for performing secure transactions using a manageability engine.

FIG. 4 is a diagram illustrating one example of an NFC stack for performing secure transactions using a secure element.

FIG. 5 is a flow diagram illustrating one example of a process for assessing a secure element or a manageability engine for performing secure transactions.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined with each other, unless specifically noted otherwise.

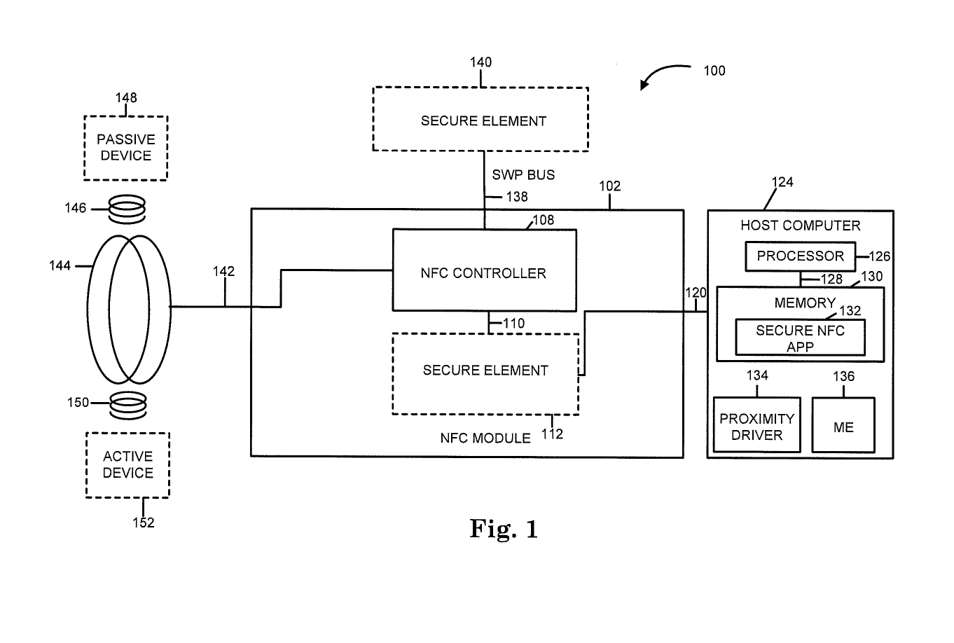

FIG. 1 is a block diagram illustrating one example of a Near Field Communication (NFC) system 100. NFC system 100 can include an NFC module 102, a host computer 124, and an antenna 144. In one example, NFC system 102 may also include a removable secure element 140. NFC module 102 may include an NFC controller 108 and an embedded secure element 112. Host computer 124 includes a processor 126 and a memory 130, which stores a secure NFC application 132. Host computer 124 also includes a proximity driver 134 and a manageability engine (ME) 136.

As will be described in detail below, secure NFC application 132 may perform secure transactions using manageability engine 136 or secure element 112 or 140 as a secure execution environment. Secure NFC application 132 accesses NFC module 102 and secure element 112 or 140 through proximity driver 134 and manageability engine 136. In this way, NFC system 100 provides flexibility by supporting secure processing by either secure element 112 or 140 or manageability engine 136. By providing the flexibility of secure processing by either the secure element or the manageability engine, the customer has the ability to choose the optimal solution to address their needs in a single system. Further, a single system that can support secure processing by either the secure element or the manageability engine may support expanded capabilities of both solutions as determined by the customer.

In one example, the determination of whether to process secure transactions using the secure element or the manageability engine is based on the solution provider. For some applications, both secure element and manageability engine solutions may be available. In this case, the customer may select the appropriate solution. For other applications, certain processing types or encryption modes may be supported by the secure element or the manageability engine, but not both. Therefore, in this case the solution is based on the processing type or encryption mode desired. Finally, for other applications, the customer may select the secure element or the manageability engine based on security concerns, processing capabilities, performance, business concerns, or trust issues.

NFC controller 108 controls the operation of NFC module 102 including passing communications between a passive device 148 or an active device 152 and host computer 124. NFC controller 108 is communicatively coupled to antenna 144 through communication link 142. In one example, NFC controller 108 is communicatively coupled to embedded secure element 112 through communication link 110, and embedded secure element 112 is communicatively coupled to host computer 124 through communication link 120. In another example, NFC controller 108 is communicatively coupled to removable secure element 140 through a single wire protocol (SWP) bus 138. In one example, removable secure element 140 is a Universal Integrated Circuit Card (U ICC). Removable secure element 140 and/or embedded secure element 112 provide secure execution environments for performing secure transactions. In one example, a secure transaction is a transaction that utilizes encryption.

Processor 126 is communicatively coupled to memory 130 through communication link 128. Processor 126 includes a Central Processing Unit (CPU) or another suitable processor. In one example, memory 130 stores machine readable instructions executed by processor 126 for operating host computer 124, such as an Operating System (OS). Memory 130 includes any suitable combination of volatile and/or non-volatile memory, such as combinations of Random Access Memory (RAM), Read-Only Memory (ROM), flash memory, and/or other suitable memory.

Memory 130 stores instructions executed by processor 126 including instructions for a secure NFC application 132. In one example, processor 126 executes instructions of secure NFC application 132 to perform secure transactions using secure element 112 or 140. Proximity driver 134 includes a host operating system stack for NFC as will be described in more detail below. Manageability engine 136 includes a chipset/firmware stack as will be described in more detail below. Manageability engine 136 provides a secure execution environment for performing secure transactions. In one example, processor 126 executes instructions of secure NFC application 132 to perform secure transactions using manageability engine 136.

In operation, NFC module 102 may communicate with either a passive device 148 or an active device 152. Passive device 148 does not have its own power supply while active device 152 has its own power supply. In one example, passive device 148 is a smart card, a credit card, a transit card, an electronic ticket, or another suitable device. In one example, active device 152 is a smart phone, a tablet computer, a laptop computer, or another suitable device.

Passive communications may be performed with passive device 148 over a wireless communication link as indicated at 146, and active communications may be performed with active device 152 over a wireless communication link as indicated at 150. For passive communications, host computer 124 starts communications with passive device 148 through NFC module 102 at a selected transfer speed. Passive device 148 is powered by the Radio Frequency (RF) field of antenna 144 and answers using load modulated data at the selected transfer speed. Passive device 148 uses load modulation to change its impedance to load down the incoming signal. This causes a voltage change that is detected and read by NFC module 102. For active communications, host computer 124 starts communication with active device 152 at a selected transfer speed. Active device 152 then answers at the selected transfer speed.

In one example, Miller coding at 106 kilo-bits per second (kbps) is used for transmissions in both passive and active modes. In passive mode, load modulation is used, and in active mode, separate discrete transmissions are used. In another example, Manchester coding is used for 212 kbps and 424 kbps transmissions.

Embedded secure element 112, removable secure element 140 and/or manageability engine 136 are available to host computer 124 as secure execution environments for secure NFC related applications and transactions without communications or application contention or conflict. NFC controller 108 is shared between embedded secure element 112, removable secure element 140, and manageability engine 136. As such, NFC controller 108 is accessible to embedded secure element 112, removable secure element 140, and manageability engine 136. In this way, secure NFC applications, such as secure NFC application 132, may access embedded secure element 112, removable secure element 140, or manageability engine 136 to perform secure transactions.

In one example, NFC controller 108 and embedded secure element 112 are both accessible via an on chip I2C bus. The I2C bus is connected to the SMBus 0 on manageability engine 136. This arrangement enables manageability engine 136 to communicate to both NFC controller 108 and secure element 112. Manageability engine 136 and NFC controller 108 allow NFC applications to perform secure transactions using either manageability engine 136 or secure element 112 or 140. In one example, upon installation of a secure NFC application, the secure NFC application is registered to use either manageability engine 136 or secure element 112 or 114 to perform secure transactions associated with the secure NFC application. This registration also enables a transaction initiated by NFC controller 108 to be appropriately recognized and steered to the appropriate secure NFC application for processing.

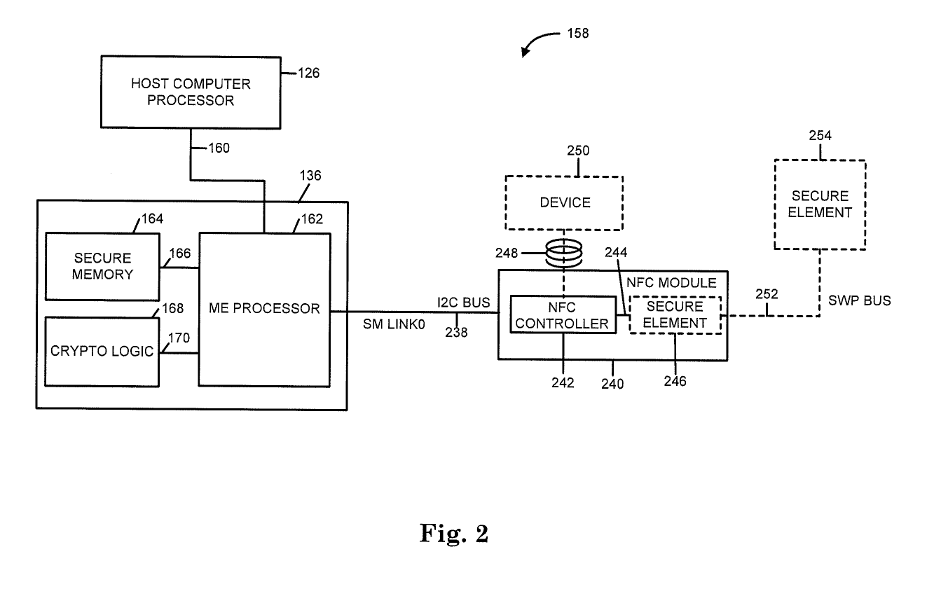

FIG. 2 is a hardware block diagram illustrating one example of an NFC system 158. NFC system 158 includes host computer processor 126, manageability engine 136, and an NFC module 240. In one example, manageability engine 136 includes a manageability engine processor 162, a secure memory 164, and crypto logic 168. Manageability engine processor 162 includes a CPU or another suitable processor. Host computer processor 126 is communicatively coupled to manageability engine processor 162 through bus 160. In one example, bus 160 is a Platform Controller Hub (PCH)/Direct Media Interface (DMI) bus. Manageability engine processor 162 is communicatively coupled to secure memory 164 through communication link 166, to crypto logic 168 through communication link 170, and to NFC module 240 through SM Link0 on I2C bus 238.

NFC module 240 includes an NFC controller 242 and in one example an embedded secure element 246. NFC controller 242 is communicatively coupled to embedded secure element 246 through communication link 244. In one example, embedded secure element 246 is communicatively coupled to a removable secure element 254 through SWP bus 252. In one example, removable secure element 254 is a UICC. NFC controller 242 may be communicatively coupled to an active or passive device 250 through a wireless communication link 248.

Manageability engine processor 162 manages NFC module 240 and routes commands between host computer processor 126, NFC controller 242, secure element 246 and/or secure element 254, and crypto logic 168. Crypto logic 168 provides a secure execution environment within manageability engine 136 that is capable of executing applets that are independent and protected against malware that may be executing on host computer processor 126. Secure memory 164 may store secrets, such as encryption keys and passwords used for performing secure transactions.

In operation, an application executing on host computer processor 126 may access secure element 246 and/or secure element 254 to perform secure transactions through manageability engine 136. Secure element 246 and/or 254 is accessed through manageability engine 136 by setting manageability engine 136 to a pass-through mode. In the pass-through mode, manageability engine processor 162 virtualizes secure element 246 and/or 254 and exposes the interface to secure element 246 and/or 254 transparently to host computer processor 126.

An application executing on host computer processor 126 may access crypto logic 168 of manageability engine 136 to perform secure transactions. In this case, manageability engine 136 is set to process secure transactions and no traffic is passed through to secure element 246 or 254. Applications use an appropriate Application Programming Interface (API) to access either secure element 246 and/or 254 or crypto logic 168. Based on the API used, manageability engine processor 162 is set to the pass-through mode to route commands to secure element 246 and/or 254 or the pass-through mode is disabled to route commands to crypto logic 168. Responses and returned data received from secure element 246 or 254 or crypto logic 168 is passed back through manageability engine processor 162 to the appropriate application.

Secure element 246 and/or secure element 254 may also be accessed through manageability engine 136 when initiated by the use of a device 250. Touching of a device 250 to NFC module 240 can cause an application to be initiated on host computer processor 126. Using information read from device 250 through wireless communication link 248, pre-defined data associations are used to determine which application is to be initiated to handle the request. If secure data or services are requested, the application uses the appropriate API as described above to access either crypto logic 168 or secure element 246 or 254 to complete the task. In one example, the pre-defined data associations are defined by the NFC Forum and use the Uniform Resource Identifier (URI) web standard. In addition, the NFC Forum allows the use of industry standardized specific data associations as defined by industry trade groups such as EMVCo, Door Access Systems, Transit Cards, and electronic tickets.

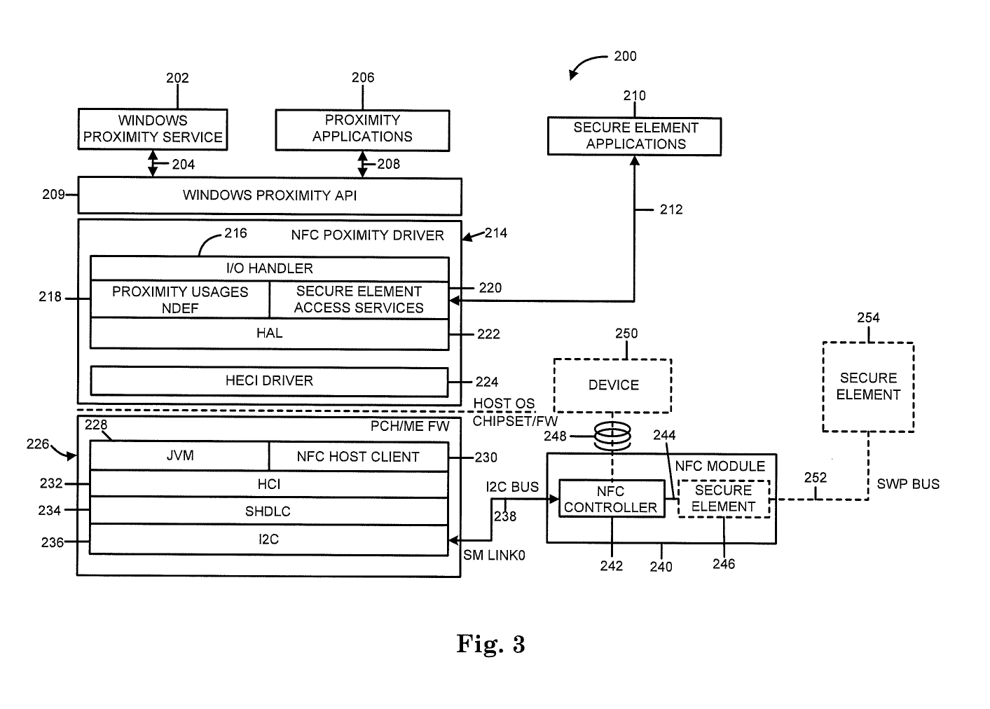

FIG. 3 is a block diagram illustrating one example of an NFC stack 200 for performing secure transactions using a manageability engine. NFC stack 200 includes an NFC proximity driver 214 and a manageability engine 226. NFC stack 200 also includes a Windows^{TM} proximity service 202, proximity applications 206, and secure element applications 210. Windows proximity service 202 enables devices running suitable applications to communicate with each other using NFC. Proximity applications 206 are applications that may communicate with a device using NFC. Secure element applications 210 are applications that may communicate with a device using NFC and that communicate with a secure execution environment to perform secure transactions.

Windows proximity service 202 is communicatively coupled to a Windows proximity Application Programming Interface (API) 209 through communication link 204. Proximity applications 206 are communicatively coupled to Windows proximity API 209 through communication link 208. Windows proximity API 209 communicates with NFC proximity driver 214. Windows proximity service 202, proximity applications 206, secure element applications 210, Windows proximity API 209, and NFC proximity driver 214 operate in the host computer operating system.

NFC proximity driver 214 includes an Input/Output (I/O) handler layer 216, a proximity usages NFC Data Exchange Format (NDEF) layer 218, a secure element access services layer 220, a Hardware Abstraction Layer (HAL) 222, and a Host Embedded Controller Interface (HECI) driver layer 224. Secure element applications 210 are communicatively coupled to secure element access services layer 220 through communication link 212. NFC proximity driver 214 communicates with Platform Controller Hub (PCH)/Manageability Engine (ME) Firmware (FW) 226 (i.e. manageability engine 226). As used herein, firmware is machine readable instructions stored in a non-volatile memory for execution by a processor.

NFC proximity driver 214 routes communications from Windows proximity service 202, proximity applications 206, and secure element applications 210 to manageability engine 226 and from manageability engine 226 to windows proximity service 202, proximity applications 206, and secure element applications 210.

Manageability engine 226 operates in the chipset/firmware of the host computer. Manageability engine 226 includes a Java Virtual Machine (JVM) layer 228, an NFC host client layer 230, a Host Controller Interface (HCI) layer 232, a Simplified High level Data Link Control (SHDLC) layer 234, and an I2C layer 236. I2C layer 236 is communicatively coupled to NFC module 240 through SM Link0 on I2C bus 238. Manageability engine 226 routes communications between NFC proximity driver 214 and NFC module 240 and provides a secure execution environment for performing secure transactions. NFC module 240 is similar to NFC module 240 previously described and illustrated with reference to FIG. 2.

In this example, secure element applications 210 perform secure transactions using manageability engine 226 as the secure execution environment. For example, to perform a secure credit card transaction, a secure element application 210 may request a one-time Card Verification Value Code (CVVC) read from a credit card. In this case, the manageability engine 226 runs an application that uses the NFC controller 242 to instruct the device 250 to generate the CVVC. The NFC controller 242 reads the CVVC from the credit card over wireless communication link 248 and sends the value to manageability engine 226. The CVVC received by the manageability engine 226 is then passed up to the secure element application 210 through NFC proximately driver 214. In this example in which manageability engine 226 is used as the secure execution environment, embedded secure element 246 and removable secure element 254 are not used.

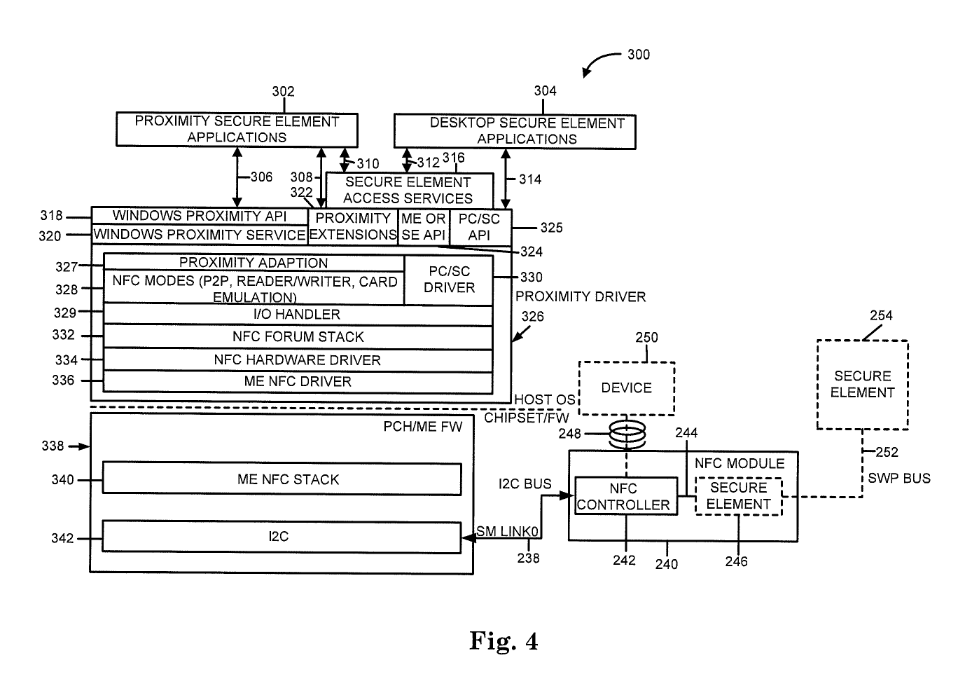

FIG. 4 is a block diagram illustrating one example of an NFC stack 300 for performing secure transactions using a secure element. NFC stack 300 includes an NFC proximity driver 326 and a manageability engine 338. NFC stack 300 also includes proximity secure element applications 302 and desktop secure element applications 304. Proximity secure element applications 302 and desktop secure element applications 304 are applications that may communicate with a device using NFC and that communicate with a secure execution environment to perform secure transactions.

Proximity secure element applications 302 are communicatively coupled to a Windows proximity API 318 through communication link 306, to proximity extensions 322 through communication link 308, or to secure element access services 316 through communication link 310. Desktop secure applications 304 are communicatively coupled to secure element access services 316 through communication link 312 or to a Personal Computer/Smart Card (PC/SC) API 325 through communication link 314.

Secure element access services 316 communicate with proximity extensions 322, manageability engine (ME) or secure element (SE) API 324, and PC/SC API 325. Windows proximity API 318 communicates with Windows proximity service 320. Windows proximity service 320, proximity extensions 322, ME or SE API 324, and PC/SC API 325 communicate with NFC proximity driver 326. Proximity secure element applications 302, desktop secure element applications 304, secure element access services 316, Windows proximity API 318, Windows proximity service 320, proximity extensions 322, ME or SE API 324, PC/SC API 325, and NFC proximity driver 326 operate in the host computer operating system.

NFC proximity driver 326 includes a proximity adaptation layer 327, an NFC modes layer 328, a PC/SC driver layer 330, an I/O handler layer 329, an NFC forum stack 332, an NFC hardware driver layer 334, and an ME NFC driver layer 336. In one example, NFC hardware driver layer 334 is excluded. NFC mode layer 328 includes a Peer to Peer (P2P) mode, a reader/writer mode, and a card emulation mode. NFC proximity driver 326 communicates with PCH/ME firmware 338 (i.e. manageability engine 338).

Manageability engine 338 includes an ME NFC stack 340 and an I2C layer 342. In one example, ME NFC stack 340 includes a JVM layer 228, an NFC host client layer 230, an HCI layer 232, and a SHDLC layer 234 as previously described and illustrated with reference to FIG. 2. I2C layer 342 is communicatively coupled to NFC module 240 through SM Link0 on I2C bus 238. NFC module 240 is similar to NFC module 240 previously described and illustrated with reference to FIG. 2.

In this example, proximity secure element applications 302 and desktop secure element applications 304 perform secure transactions using embedded secure element 246 or removable secure element 254 as the secure execution environment. The secure transactions are routed through manageability engine 338. Depending upon the application, proximity secure element applications 302 and desktop secure element applications 304 may take different paths through proximity driver 326.

In one example, for a desktop secure element application 304 using for example a smart card device for device 250, the desktop secure element application 304 communicates with PC/SC API 325. PC/SC API 325 communicates with PC/SC driver 330 of proximity driver 326. PC/SC driver 330 then communicates with I/O handler 329 to pass communications through the lower layers of proximity driver 326 and through manageability engine 338 to NFC module 240. Embedded secure element 246 or removable secure element 254 performs secure transactions requested by the desktop secure element application 304 and returns the results to the desktop secure element application 304 through manageability engine 338, proximity driver 326, and PC/SC API 325.

In another example, for a desktop secure element application 304 used for example for secure element or smart card administration, the desktop secure element application 304 communicates with ME or SE API 324 through secure element access services 316. ME or SE API 324 communicates with PC/SC driver 330 of proximity driver 326. PC/SC driver 330 then communicates with I/O handler 329 to pass communications through the lower layers of proximity driver 326 and through manageability engine 338 to NFC module 240. Embedded secure element 246 or removable secure element 254 performs secure transactions requested by the desktop secure element application 304 and returns the results to the desktop secure element application 304 through manageability engine 338, proximity driver 326, ME or SE API 324, and secure element access services 316.

In another example, for a proximity secure element application 302 using for example an NFC Forum Type 4 smart card device for device 250, such as a transit card or electronic ticket, the proximity secure element application 302 communicates with Windows proximity API 318. Windows proximity API 318 communicates with proximity adaptation layer 327 of proximity driver 326 through Windows proximity service 320. Proximity adaptation layer 327 then communicates with I/O handler 329 through NFC modes layer 328 to pass communications through the lower layers of proximity driver 326 and through manageability engine 338 to NFC module 240. Embedded secure element 246 or removable secure element 254 performs secure transactions requested by the proximity secure element application 302 and returns the results to the proximity secure element application 302 through manageability engine 338, proximity driver 326, Windows proximity service 320, and Windows proximity API 318.

In another example, for a proximity secure element application 302, the proximity secure element application 302 communicates with proximity extensions 322 through secure element access services 316. Proximity extensions 322 communicate with PC/SC driver 330 of proximity driver 326. PC/SC driver 330 then communicates with I/O handler 329 to pass communications through the lower layers of proximity driver 326 and through manageability engine 338 to NFC module 240. Embedded secure element 246 or removable secure element 254 performs secure transactions requested by the proximity secure element application 302 and returns the results to the proximity secure element application 302 through manageability engine 338, proximity driver 326, proximity extensions 322, and secure element access services 316.

In another example, for a proximity secure element application 302 using for example NFC vendor specific extensions, the proximity secure element application 302 communicates with proximity extensions 322. Proximity extensions 322 communicate with proximity adaptation layer 327 of proximity driver 326. Proximity adaptation layer 327 then communicates with I/O handler 329 through NFC modes layer 328 to pass communications through the lower layers of proximity driver 326 and through manageability engine 338 to NFC module 240. Embedded secure element 246 or removable secure element 254 performs secure transactions requested by the proximity secure element application 302 and returns the results to the proximity secure element application 302 through manageability engine 338, proximity driver 326, and proximity extensions 322.

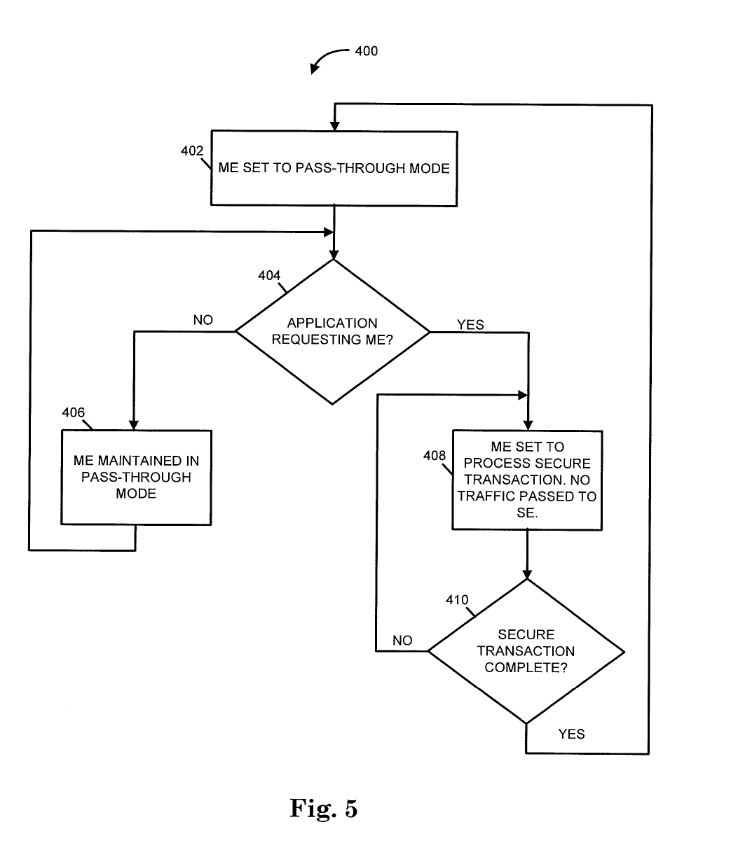

FIG. 5 is a flow diagram illustrating one example of a process 400 for assessing a secure element or a manageability engine for performing secure transactions. At 402, the manageability engine is set to the pass-through mode such that the manageability engine routes commands for secure transactions to a secure element. At 404, it is determined whether an application is requesting access to the manageability engine to perform a secure transaction. If an application is not requesting access to the manageability engine to perform a secure transaction, then at 406 the manageability engine is maintained in the pass-through mode.

If an application is requesting access to the manageability engine to perform a secure transaction, then at 408 the manageability engine disables the pass-through mode and is set to process the secure transaction. With the manageability engine set to process the secure transaction, no traffic is passed through to a secure element. At 410, it is determined whether the secure transaction is complete. If the secure transaction is not complete, then the manageability engine remains set to process the secure transaction at 408. If the secure transaction is complete, then the manageability engine is again set to the pass-through mode at 402.

Accordingly, examples of the disclosure provide an NFC system including an NFC module in which secure applications may perform secure transactions using a manageability engine or a secure element as the secure execution environment. The secure applications access the NFC module and a secure element of the NFC module through the manageability engine.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A system comprising:
a Near Field Communication (NFC) module comprising a secure element; and
a host computer communicatively coupled to the NFC module, the host computer comprising a manageability engine;
wherein a secure NFC application of the host computer is to access the secure element through the manageability engine.

2. The system of claim 1, wherein the NFC module comprises an NFC controller communicatively coupled to the secure element, and
wherein the host computer is communicatively coupled to the NFC controller.

3. The system of claim 1, wherein the manageability engine comprises a processor communicatively coupled to the NFC module and crypto logic communicatively coupled to the processor.

4. The system of claim 1, wherein the host computer comprises a proximity driver communicatively coupled to the manageability engine, and
wherein the secure NFC application of the host computer is to access the secure element through the proximity driver.

5. The system of claim 1, wherein the secure element is an embedded secure element.

6. The system of claim 1, wherein the secure element is a removable secure element.

7. The system of claim 6, wherein the removable secure element comprises a Universal Integrated Circuit Card (U ICC).

8. A system comprising:
a Near Field Communication (NFC) module comprising a secure element; and
a host computer comprising a manageability engine communicatively coupled to the NFC module;
wherein a secure element application of the host computer is to perform secure transactions using one of the manageability engine and the secure element, the secure element being accessed through the manageability engine.

9. The system of claim 8, wherein the NFC module comprises an NFC controller communicatively coupled to the secure element, and
wherein the manageability engine is communicatively coupled to the NFC controller through an I2C bus.

10. The system of claim 8, wherein the secure element comprises one of an embedded secure element and a removable secure element.

11. The system of claim 10, wherein the removable secure element comprises a Universal Integrated Circuit Card (UICC) communicatively coupled to the NFC module through a Single Wire Protocol (SWP) bus.

12. The system of claim 8, wherein the manageability engine comprises a processor communicatively coupled to the NFC module through an I2C bus, crypto logic communicatively coupled to the processor, and a secure memory communicatively coupled to the processor.

13. A system comprising:
a processor; and
a memory communicatively coupled to the processor, the memory storing machine readable instructions causing the processor, after execution of the instructions by the processor, to:
execute a secure Near Field Communication (NFC) application;
and
access the NFC module through a manageability engine to perform a transaction for the NFC application.

14. The system of claim 13, wherein the memory stores machine readable instructions causing the processor, after execution of the instruction by the processor, to:
access a secure element of the NFC module through the manageability engine to perform a secure transaction for the NFC application.

15. The system of claim 13, wherein the memory stores machine readable instructions causing the processor, after execution of the instruction by the processor, to:
access the manageability engine to perform a secure transaction for the NFC application.
